(19) United States
(12) Patent Application Publication
(10) Pub. No.: US 2022/0358527 A1
(43) Pub. Date: Nov. 10, 2022

(54) METHOD FOR PREDICTING SALES ORDER

(71) Applicant: STAR RAPID MANUFACTURING LIMITED, Zhongshan City, Guangdong (CN)

(72) Inventors: Manjeet SINGH, Zhongshan City (CN); Gordon STYLES, Zhongshan City (CN)

(73) Assignee: STAR RAPID MANUFACTURING LIMITED, Zhongshan City, Guangdong (CN)

(21) Appl. No.: 17/627,265

(22) PCT Filed: Oct. 9, 2020
(86) PCT No.: PCT/CN2020/119885

§ 371 Date: Jan. 14, 2022

(30) Foreign Application Priority Data
Aug. 26, 2020 (CN) 202010871637.3

(51) Int. Cl. G06Q 30/02

(52) U.S. Cl. CPC G06Q 30/0202

(57) ABSTRACT

A method for predicting sales order comprises the following steps: Step 1: obtaining information of multiple inquiry cases, and building inquiry original dataset based on the information of inquiry cases; step 2: randomly and with replacement, drawing m training samples from the inquiry original dataset as a training set; step 3: randomly selecting N features from the original dataset, training the selected features through the training set, and building a decision tree; step 4: repeating the steps 2 and 3 to build a total of Y decision trees to form a random forest model; step 5: importing the data to be predicted into the random forest model, and each decision tree votes on the imported data, and the probability of winning the sales order is determined based on the voting results. The invention can predict the probability of winning sales orders during the customer inquiry stage.

### FIELD OF THE INVENTION

The invention relates to the technical field of intelligent algorithm, in particular to a method for predicting sales orders.

### BACKGROUND OF THE INVENTION

With the gradual development of business, inquiry and consultation before purchasing products has become a very common business practice. It is a well-known principle that the more potential users consulted, the greater the probability of winning sales orders finally. Although this principle has been well-known by the public, there are many factors affecting winning orders, the change of each affecting factor will lead to a change in the result, the existing technology has never effectively predicted whether an order can be signed or not.

### SUMMARY OF THE INVENTION

The invention provides a method for predicting sales orders, which can predict the probability of winning sales orders during customer inquiry stage.

The invention provides a method for predicting sales orders, comprising the following steps:

step 1: obtaining information of multiple inquiry cases, and building inquiry original dataset based on the information of inquiry cases, the original dataset comprises customer name, customer industry, level of salespeople connected with customers, inquiry date, order amount, order quantity, customer complaint quantity, on-time delivery index, quotation spent time, product fit, company fit, contact role, company size, process, price of requote and inquiry result;

step 2: randomly and with replacement, drawing m number of training samples from the inquiry original dataset as a training set;

step 3: randomly selecting N number of features from the original dataset, training the selected features through the training set, and building a decision tree;

step 4: repeating the steps 2 and 3 to build Y number of decision trees to form a random forest model;

step 5: importing data to be predicted into the random forest model, and each decision tree votes on the imported data, and the probability of winning the sales order is determined based on the voting results.

Preferably, the determination of the probability of winning the sales order based on the voting results, specifically comprising: dividing the number of decision trees whose voting result is winning sales orders by the total number of decision trees to obtain the probability of winning sales orders.

Preferably, the inquiry original dataset comprises at least an original training set and at least an original testing set, in the step 2, m training samples are randomly drawn with replacement from the original training set as the training set; after step 4, the method further comprises the following steps: importing the data in the original test set into the random forest model to determine the prediction accuracy of the random forest model.

Preferably, in step 5, the data to be predicted includes customer name, when the customer name is obtained, search the customer name through a preset network resource database, and grab information of the customer industry and the company size from the search results.

Preferably, after the information of the customer industry and the company size are grabbed from the search results, the method further comprises the following step: determining the company fit based on the industry information of the customer.

Preferably, the step of building an inquiry original dataset based on the inquiry information specifically includes: filtering out the data of customers name, customers industry, level of salespeople connected with customers, inquiries date, order amount, order quantity, customer complaint quantity, on-time delivery index, quotation spent time, product fit, company fit, contact role, company size, process, price of requote and inquiry result from information of the inquiry cases, when an item of data is missing, the preset data is used to fill in the missing data.

Preferably, step 5 specifically includes: when a salespeople connected with a customer communicate with the customer by telephone, record the voice information of the telephone communication, convert the voice information into text information, extract data to be predicted from the text information, system automatically imports the extracted data to be predicted into the random forest model, and each decision tree votes on the imported data to determine the probability of winning the sales order based on the voting results.

The invention has the following technical effects: the invention uses the random forest model to obtain customer consultation information during the customer inquiry stage, vote for whether an order can be won through each decision tree, and then determine the probability of winning the order based on the voting results of all decision trees.

### DETAILED DESCRIPTION OF THE INVENTION

The invention provides a method for predicting sales order, which is applied to prediction systems for sales order, the prediction system for sales order may be a software system developed to realize the method for predicting sales order of the invention. The method for predicting sales order comprises the following steps: Step 1: Obtaining information of multiple inquiry cases, and building inquiry original dataset based on the information of inquiry cases, the original dataset comprises customer name, customer industry, level of salespeople connected with customers, inquiry date, order amount, order quantity, customer complaint quantity, on-time delivery index, quotation spent time, product fit, company fit, contact role, company size, process, price of requote and inquiry result.

The inquiry case information refers to customer inquiry cases recorded in history. Whenever a customer makes an inquiry, the information in the inquiry process shall be recorded, these inquiry cases include cases that have successfully won sales orders and cases that have not successfully won sales orders, therefore, there are multiple customer inquiry cases, the inquiry cases information can be extracted from these historical inquiry cases, and the inquiry original dataset is built based on the inquiry cases information, specifically, the inquiry cases information is data processed to obtain the inquiry original dataset. The inquiry original dataset comprises multiple inquiry case samples. and each inquiry case sample includes customer name, customer industry, level of salespeople contacted with customers, inquiry date, order amount, order quantity, customer complaint quantity, on-time delivery index, quotation spent time, product fit, company fit, contact role, company size, process, price of requote and inquiry result. The customer name can be a full name or abbreviation of the inquiry customer. The industry of the customer can be the industry of the inquiry customer. Generally, salespeople is arranged to connect with inquiry customers. Salespeople with different business abilities have different levels. The stronger the business ability, the higher the level, and the higher the probability of winning sales orders. The level of salespeople contacted with customers can be recorded in digital form. The inquiry date is the date of the customer's first inquiry, accurate to the year, month, and day. The order amount is the total amount of the order to be signed, and the order quantity is the quantity of products in the order to be signed. The customer complaint quantity is the customer's historical complaint quantity. Whenever the customer has a complaint, the system can accumulate the user's complaint time. The on-time delivery index is how punctual the customer expects to deliver. Usually, the actual delivery time is divided by the agreed time to obtain a ratio, which is the on-time delivery index. The quotation spent time is the time from the customer's first consultation to the quotation. The product fit is the matching degree between the product that the customer wants to buy and the product that is actually sold. The company fit is the matching degree between the consulting client and the seller's client. The contact role is the role of the inquiry contact person in its company, which can be reflected by the position of the contact person, such as CEO or purchasing manager, etc. The higher the position, the more the right to speak, the greater the probability of winning the order. The company size is the size of the inquiry company, which can be reflected by the number of employees or by the annual sales of users. The process is the process through which the inquiry customer wants the product to be processed, it can be digitized as the complexity of product processing, which is reflected by the number of product processing procedures. The price of requote is the price inquired again after customer's inquiry. The inquiry result is whether or not to sign a sales order in the end, which can be represented by numbers. 1 means that the sales order has been successfully signed, and 0 means that the sales order has not been signed.

Step 2: Randomly and with replacement, drawing m number of training samples from the inquiry original dataset as a training set. The inquiry original dataset includes multiple samples, and m number of samples are randomly drawn with replacement from the inquiry original dataset, these samples are training samples. The drawn training samples form a training set, which is used to train the random forest model in the subsequent steps.

Step 3: Randomly selecting N number of features from the original dataset, training the selected features through the training set, and building at least a decision tree. The customer name, customer industry, level of salespeople contacted with customers, inquiry date, order amount, order quantity, customer complaint quantity, on-time delivery index, quotation spent time, product fit, company fit, contact role, company size, process and price of requote included in the original dataset are all features, and N number of features can be randomly selected from these features, and N should naturally be less than or equal to the total number of features included in the original dataset. In this embodiment, the total number of features included in the original dataset is 15. In this way, if N number of features are randomly selected from the original dataset, there are the following P number of selection methods:

P=C₁¹⁵+C₂¹⁵+C₃¹⁵+C₄¹⁵+C₅¹⁵+C₆¹⁵+C₇¹⁵+C₈¹⁵+C₉¹⁵+C₁₀¹⁵+C₁₁¹⁵+C₁₂¹⁵+C₁₃¹⁵+C₁₄¹⁵+C₁₅¹⁵

A decision tree is built for each selected feature, and the training set is used to train each decision tree. Each node of the decision tree will classify a case in the training set according to the feature, for example, a decision tree will first check whether the company has 50-500 employees, and if the answer is yes, go to the next question-whether the company matches the business of the seller company, if it does not match, it is determined that the sales order cannot be won, if it matches, it can be further judged whether the products required by the company match the products of the seller company, if it matches, the decision tree will determine that the sales order can be won. Therefore, the training result is compared with the actual inquiry result of each case to calculate the accuracy of each decision tree, and the decision tree with the highest accuracy is selected from it, which is the decision tree corresponding to the training sample.

Step 4: Repeating the step 2 and step 3 to build Y number of decision trees to form a random forest model. Repeating the steps 2 and 3, so that Y number of decision trees are obtained, and the number of Y can be specified according to actual needs, thereby forming a random forest model composed of Y number of decision trees.

Step 5: Importing the data to be predicted into the random forest model, and each decision tree votes on the imported data, and the probability of winning the sales order is determined based on the voting results. If there is need to predict whether a sales contract of an inquiry customer can be won, record the inquiry data of the inquiry customer during the inquiry process, these inquiry data includes customer name, customer industry, level of salespeople contacted with customers, inquiry date, order amount, order quantity, customer complaint quantity, on-time delivery index, quotation spent time, product fit, company fit, contact role, company size, process and price of requote. Importing the inquiry data to be predicted into the random forest model, and each decision tree votes on the imported data to determine whether the sales contract of the inquiry customer can be won. According to the classification results of all decision trees, the final probability of winning the sales order is obtained.

In an embodiment, the step of determining the probability of winning the sales order based on the voting result in step 5, specifically comprising: dividing the number of decision trees whose voting result is winning sales orders by the total number of decision trees to obtain the probability of winning sales orders. For each decision tree, if the voting result of the decision tree is yes for winning the sales order, the output result is set to 1, and if the voting result of the decision tree is losing the sales order, the output result is set to 0, accumulate the output results of all decision trees, and divide the accumulated result by the total number of decision trees to obtain the probability of winning the sales order.

In an embodiment, the inquiry original dataset initially built comprises at least an original training set and at least an original testing set, the original training set is used to train the random forest model, the testing set is used to test the calculation process of the model to verify the accuracy of the output results of the random forest model. The number of samples in the original training set and the original testing set can be determined based on the ratio of 8:2. Therefore, in the step 2, m number of training samples are randomly drawn with replacement from the original training set as a training set, instead of drawing training samples from the original testing set. After the step 4, the method further comprises the following steps: importing the data in the original test set into the random forest model to determine the prediction accuracy of the random forest model. The step 4 determines the final random forest model, but the accuracy of the random forest model needs to be verified. In this embodiment, the data in the original testing set is imported into the determined random forest model, the classification results are output by the random forest model, and the prediction accuracy of the random forest model can be determined by comparing the classification results with the real inquiry results of each sample. If the prediction accuracy is greater than the preset accuracy threshold, the random forest model is retained, and if the prediction accuracy is less than the preset accuracy threshold, the random forest model needs to be modified.

In the above embodiment, the system can provide a data entry interface, after communicating with the inquiry personnel, the salespeople can record data such as customer name, customer industry, level of salespeople contacted with customer, inquiry date, order amount, order quantity, customer complaint quantity, on-time delivery index, quotation spent time, product fit, company fit, contact role, company size, process and price of requote, and then directly enter the above information into the system, the system will output the prediction results from the random forest model for the reference of the salespeople.

In an embodiment, for part of data, there is no need for the salespeople to manually enter, in the step 5, the data to be predicted entered by the salespeople comprises customer name, when the system obtains the customer name, the system will automatically access the preset network resource database, such as enterprise information resource database, and search the customer name in the network resource database to obtain the corresponding search results, these results contain a variety of information about the customer. The industry information and company size information of the customer can be grabbed from the search results, which saves the manual entry of some data.

In an embodiment, after the industry information and company size information of the customer are grabbed from the search results, the method further comprises the following steps: determining the company fit based on the industry information of the customer. The business scope of the seller company is pre-stored in the system, the business scope usually includes multiple subdivision fields, which are usually expressed in short words. The customer's subdivision fields can be compared with the seller company's subdivision fields, the number of the same subdivision fields is recorded, and this number is compared with the number of subdivision fields of the business scope of the seller company, when the ratio is greater than the predetermined number, it can be determined that the customer's company fit is high, otherwise, it can be determined that the customer's company fit is low.

In an embodiment, in the step 1, the step of building an inquiry original dataset based on the inquiry case information specifically comprises: filtering out the data of customer name, customer industry, level of salespeople contacted with customers, inquiry date, order amount, order quantity, customer complaint quantity, on-time delivery index, quotation spent time, product fit, company fit, contact role, company size, process, price of requote and inquiry result from information of the inquiry cases, when an item of data is missing, the preset data is used to fill in the missing data. The information of inquiry case may only contain part of the information, and there may be some missing data. In order to ensure the integrity of the data calculation, the missing data can be filled with other data, usually filled with “0”.

In an embodiment, the step 5 specifically comprises: when the salespeople who is in contact with a customer communicate with the customer by telephone, record the voice information of the telephone communication, convert the voice information into text information, extract data such as customer name, customer industry, level of salespeople contacted with customer, inquiry date, order amount, order quantity, customer complaint quantity, on-time delivery index, quotation spent time, product fit, company fit, contact role, company size, process and price of requote from the text information, the system automatically imports the extracted data into the random forest model, and each decision tree votes on the imported data to determine the probability of winning the sales order based on the voting results, which realizes an automatic data reading and entering, and saves the tedious manual entry system. During the dialogue with customers, the salespeople can ask users guiding questions, which will guide the users to say the information of customer name, customer industry, level of salespeople contacted with customers, inquiry date, order amount, order quantity, customer complaint quantity, on-time delivery index, quotation spent time, product fit, company fit, contact role, company size, process, price of requote and other information, so as to extract the above data from the text information.

The above content is a further detailed description of the invention in combination with specific embodiments, and it cannot be considered that the specific implementation of the invention is limited to these descriptions. For those of ordinary skill in the technical field to which the invention belongs, several simple deductions or substitutions can be made without departing from the concept of the invention.

1. A method for predicting sales order, comprising the following steps:
step 1: obtaining information of multiple inquiry cases, and building inquiry original dataset based on the information of inquiry cases, the original dataset comprises customer name, customer industry, level of salespeople connected with customers, inquiry date, order amount, order quantity, customer complaint quantity, on-time delivery index, quotation spent days, product fit, company fit, contact role, company size, process, price of requote and inquiry result;
step 2: randomly and with replacement, drawing m number of training samples from the inquiry original dataset as a training set;
step 3: randomly selecting N number of features from the original dataset, training the selected features through the training set, and building a decision tree;
step 4: repeating the steps 2 and 3 to build Y number of decision trees to form a random forest model;
step 5: importing data to be predicted into the random forest model, and each decision tree votes on the imported data, and the probability of winning the sales order is determined based on the voting results.

2. The method of claim 1, wherein the determination of the probability of winning the sales order based on the voting results, specifically comprising: dividing the number of decision trees whose voting result is winning sales orders by the total number of decision trees to obtain the probability of winning sales orders.

3. The method of claim 1, wherein the inquiry original dataset comprises at least an original training set and at least an original testing set, in step 2, m training samples are randomly drawn with replacement from the original training set as the training set; after step 4, the method further comprises the following steps: importing the data in the original test set into the random forest model to determine the prediction accuracy of the random forest model.

4. The method of claim 1, wherein in the step 5, the data to be predicted includes customer name, when the customer name is obtained, search the customer name through a preset network resource database, and grab information of the customer industry and information of the company size from the search results.

5. The method of claim 4, wherein after the information of the customer industry and the company size are grabbed from the search results, the method further comprises the following step: determining the company fit based on the industry information of the customer.

6. The method of claim 1, wherein the step of building an inquiry original dataset based on the inquiry information specifically includes: filtering out the data of customers name, customers industry, level of salespeople contacted with customers, inquiries date, order amount, order quantity, customer complaint quantity, on-time delivery index, quotation spent time, product fit, company fit, contact role, company size, process, price of requote and inquiry result from information of the inquiry cases, when an item of data is missing, the preset data is used to fill in the missing data.

7. The method of claim 1, wherein the step 5 specifically includes: when a salespeople who is in contact with a customer communicate with the customer by telephone, record the voice information of the telephone communication, convert the voice information into text information, extract data to be predicted from the text information, system automatically imports the extracted data to be predicted into the random forest model, and each decision tree votes on the imported data to determine the probability of winning the sales order based on the voting results.
